(19) United States
(12) Patent Application Publication
(10) Pub. No.: US 2005/0017834 A1
(43) Pub. Date: Jan. 27, 2005

(54) Electromechanical stepping switching apparatus having temporally controlled additional functions

(75) Inventors: Egon Feisthammel, Rastatt (DE); Ralf Grobleben, Bretten (DE); Joachim Grutzke, New Bern, NC (US); Dieter Rosmann, Stuttgart (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/873,389

(22) Filed: Jun. 21, 2004

Related U.S. Application Data
(63) Continuation of application No. PCT/EP02/13458, filed on Nov. 28, 2002.

(30) Foreign Application Priority Data
Dec. 21, 2001 (DE) 101 63 194.4

(51) Int. Cl. H01H 9/00

(52) U.S. Cl. 335/207

(57) ABSTRACT

The production costs of a multiple contact switch with a time function are simplified and reduced. The electromechanical switch is manually operated one way and it is reset by an electric pulse. The novel switch may be combined with other switches to form a device block switch such as is typically used in extractor hoods and the like. Time-controlled intensive steps and time-delay steps can be created with the novel system.

### CROSS-REFERENCE TO RELATED APPLICATION

This application is a continuation, under 35 U.S.C. § 120, of copending international application No. PCT/EP02/13458, filed Nov. 28, 2002, which designated the United States; this application also claims the priority, under 35 U.S.C. § 119, of German patent application No. 101 63 194.4, filed Dec. 21, 2001; the prior applications are herewith incorporated by reference in their entirety.

### BACKGROUND OF THE INVENTION

### Field of the Invention

The present invention relates to a switching apparatus for controlling devices having a mechanical stepping switching element for mechanically switching a functionality of a device. In particular, the present invention relates to a switching apparatus for controlling the intensity stages of an extractor hood.

U.S. Pat. No. 5,690,093 describes an extractor hood with an electronic control system. The control device essentially consists of a microprocessor which drives the fan motor accordingly. The desired functions are input by way of a keypad. In addition to a number of pushbuttons for various intensity stages, a pushbutton is also provided for running on the extractor hood. However, the pushbuttons only act as pulse generators for the microprocessor. Purely electronic momentary-contact control is therefore provided. The production costs of such electronic momentary-contact control systems are relatively high.

German published patent application DE 198 02 332 A1 discloses an electronic rocker switch, in which a movable contact part bridges stationary contacts. The movable contact part is loaded by a spring toward one switching position and, in the other switching position, by way of a magnet that is in the form of a permanent magnet. The magnetic field of the permanent magnet can be influenced by the magnetic field of an electromagnet such that the movable contact part, which is held in a prestressed state, is moved over into its other switching position when the magnetic field of the electromagnet is built up.

### SUMMARY OF THE INVENTION

It is accordingly an object of the invention to provide a switching apparatus, which overcomes the above-mentioned disadvantages of the heretofore-known devices and methods of this general type and which provides for a switching apparatus that is suitable for use in controlling a device and that is improved in terms of production costs.

With the foregoing and other objects in view there is provided, in accordance with the invention, a switching apparatus for controlling a device, such as a household appliance, an air conditioner, a ventilator, or the like. The apparatus comprises:
a mechanical stepping switching element connected to control the device and configured to assume a plurality of switching positions;
the switching element assuming one or more first switching positions by manual actuation; and
electrical means disposed to inject an electrical pulse to reset the switching element from the first switching position to a second switching position.

In other words, the objects of the invention are achieved by a switching apparatus for controlling devices having a mechanical stepping switching element which can be switched to a number of switching positions, the stepping switching element having at least one first switching position, into which it can be moved manually and from which it can be reset to a second switching position by means of an electrical pulse.

The advantage of the switching apparatus according to the present invention is that, by means of a timing element, the mechanical stepping switch may be designed to have a time-delay function, resulting in considerable cost advantages as compared with purely electronic solutions from the prior art. Such a stepping switch can be combined with further switches to form a switch block for household appliances, air-conditioning and ventilation devices, miniature devices and the like.

Further advantages consist in the fact that no standby mode is required for the electromechanical stepping switch according to the invention, since it can always be operated mechanically. There is thus no longer the considerable energy consumption for the standby mode.

The electromechanical stepping switch having pushbuttons is also considerably less susceptible to faults than purely electronic pressure switches. The essentially mechanical pushbutton switch may have considerably greater electromagnetic compatibility in particular with respect to electromagnetic interference.

In addition, the device to be controlled can be isolated clearly from the power supply system using the electromechanical stepping switch. This is advantageous not only from a safety standpoint but also for the design of further electronic components in the device.

Other features which are considered as characteristic for the invention are set forth in the appended claims.

Although the invention is illustrated and described herein as embodied in a electromechanical stepping switching apparatus having temporally controlled additional functions, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a sketch illustrating the basic operation of an electromechanical stepping switch according to the invention;

FIG. 2 is a plan view of a switching apparatus having the stepping switch according to the invention and a number of pushbuttons;

FIG. 3 is a similar view showing a variant of the switching apparatus shown in FIG. 2;

FIGS. 4A, 4B, and 4C are plan view of a number of variants of a control panel having rocker switches for an electromechanical stepping switch according to the invention;

FIG. 5 sis a slightly larger view of a variant of the control panels of FIGS. 4A to C having an additional intensity stage;

FIG. 6 is a plan view of a rotary switch according to the invention as a stepping switch;

FIG. 7 is a further plan view of a variant of the rotary switch shown in FIG. 6; and

FIG. 8 is a schematic plan view of a sliding switch according to the invention, forming as a stepping switch.

### DESCRIPTION OF THE PREFERRED EMBODIMENTS

Referring now to the figures of the drawing in detail and first, particularly, to FIG. 1 thereof, there is shown, for the purpose of explaining the basic operation of the stepping switch according to the invention, a pushbutton which is held in the switched-on state after operation and can be switched off by an electrical pulse after a desired time interval. A button element 1 is held in a sprung manner against a housing 3, which is only illustrated in its basic form, by means of a helical spring 2. An electrical contact element 4 is fitted to that end of the button element 1 distal from the button surface. An electrical opposing contact 5 lies opposite the electrical contact element 4 in the direction of movement of the button, and is disposed on one side of the core of an electromagnet 6. A permanent magnet 7 is located at the other end of the core of the electromagnet 6.

When the button is operated manually, i.e., the button is pushed downwardly in the figure, the electrical contact between the contact elements 4 and 5 closes and the button is in an electrical ON state. The pushbutton switch then remains in this ON state, since the electrical contact element 4 is held by the permanent magnet 7 across the core of the electromagnet 6 counter to the spring force of the spring 2.

For the purpose of switching the pushbutton switch into the OFF state, a short pulse is applied to the electromagnet 6. The electrical pulse is in this case fixed such that its magnetic field induced in the coil of the electromagnet counteracts the magnetic field of the permanent magnet 7. This reduces the magnetic force exerted on the electrical contact element 4. As a result, the spring 2 pushes the button element 1 upward, opens the electrical contact, and thus moves the pushbutton switch into the OFF state.

The electrical pulse for the electromagnet 6 may be a control pulse from a control device 28, in particular the pulse of a time-delay switching element.

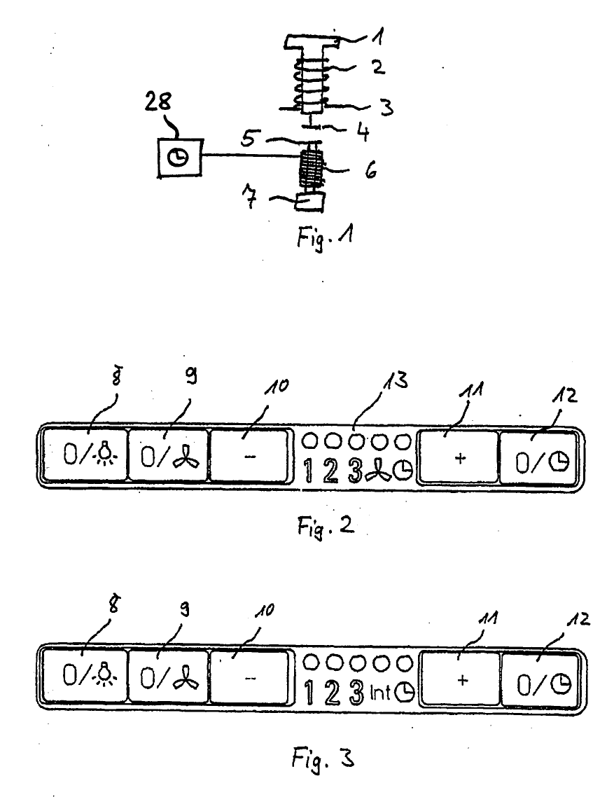

FIG. 2 shows a schematic illustration of a front view of a control element of an extractor hood. All of the switches 8 to 12 are in the form of pushbutton switches. The switch 8 serves the purpose of switching the light on and off. The switch 9 serves the purpose of resetting the fan of the extractor hood or turning it off and on.

Intensity stages for the fan or speed stages for the fan motor can be set using a stepping switch 10, 11. The stepping switch 10, 11 is configured as a flat-mounted rotary switch with two pushbuttons. The fan stage can be stepped up by way of the (+) button 11 and stepped down by way of the (−) button 10. The rotary switch is moved by way of a pushbutton which is coupled to a driver mechanism. It can rotate in both directions for the purpose of stepping up and stepping down the stages. When using the button 9 to switch the fan on and off, the most recently selected fan stage is set, resulting, in a convenient manner, in a memory function.

The extractor hood is also equipped with a run-on stage (after-running stage) which can be switched on by way of the button 12. In the same way as the stepping switch, the button 12 has a temporally controlled release mechanism by magnetic fields being superimposed, as described with reference to FIG. 1. In addition, the button 13 for the run-on stage may be mechanically coupled with other buttons by way of slides, such that mutual tripping and blocking counter to simultaneous pressure is ensured.

The run-on stage can be switched on in any operating state, i.e., in any fan stage. It remains active for a predetermined period of time and then deactivates itself. In this case, the device switches itself off completely.

The run-on stage can be switched off at any time, like the other stages, by means of the off or reset button 9. The fan then continues to run in continuous operation in the most recently used stage. Furthermore, the run-on stage can likewise be switched off at any time by pressing the run-on button 12 again. The fan thus switches itself off.

The fan stage can be changed at any time during the run-on time. The fan then continues to run over the remaining time in the newly selected stage.

Between the buttons of the stepping switch 10, 11 there is a display panel 13 which has light-emitting diodes for displaying the respectively active fan stage. Alternatively, a mechanical slide gate which is coupled to the stepping switch is also conceivable.

The run-on function could also be displayed by way of a light-emitting diode integrated in the button 12, in contrast to the illustration in FIG. 2. Also conceivable is a mechanical display element which is integrated correspondingly in the pushbutton in the run-on stage.

FIG. 3 shows the schematic view of a control panel of a pushbutton switch block, which also has an intensive switching stage. In other words, the embodiment shown in FIG. 3 comprises an intensive stage and a run-on stage. The intensive stage is preferably mechanically coupled with the run-on stage. This is intended to ensure that either the intensive stage or the run-on stage can be operated, but not both at the same time.

The (+) button 11 of the stepping switch serves the purpose of activating the intensive stage. The end position “+” of the rotary switch has, after stage 3, a spring-assisted stop. When it is intended to switch over to the intensive stage, the spring force of the stop must be overcome by pressing the button further. A time-delay switching element which is explained in connection with FIG. 1 is inbuilt at this end position. The time-delay switching element holds the rotary switch in the intensive stage position for the predetermined period of time.

The intensive stage makes it possible to step up to a maximum motor speed range for a short period of time. It can be switched on after stage 3 of the fan and remains switched on for the predetermined period of time, unless it is interrupted by the pushbutton switch 9 by switching off the fan motor. Once the period of time for which the intensive stage is switched on has expired, the electromagnet releases the contact and a switching element is automatically pushed back to the stage 3 position by a spring-assisted stop. The fan then continues to run in stage 3. The intensive stage may also be switched off manually using the button 10 at any time before the predetermined period of time has expired.

The stepping switch according to the invention can likewise be used to control other special functions in addition to the intensive or run-on function. The stepping switch is advantageously part of a modular system which comprises further pressure switches, for examples buttons 8, 9 and 12, and which can be used to implement any operating device concepts.

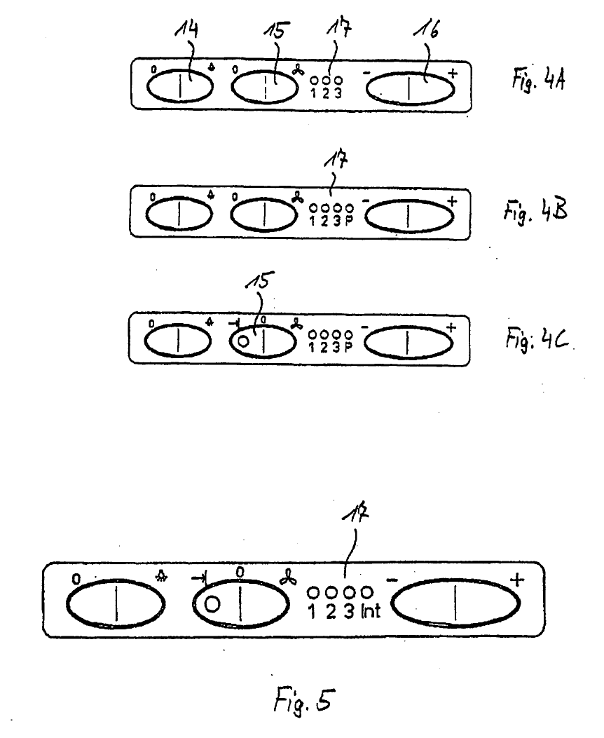

Further embodiments of the electromechanical stepping switch according to the invention are explained below in connection with FIGS. 4 to 8. Their basic operation corresponds to that which has already been described in connection with the pushbutton stepping switches shown in FIGS. 2 and 3.

FIG. 4A shows the control panel of a switch block for extractor hoods having rocker switches. In a basic version, a rocker switch 14 is provided for the purpose of switching the light of the extractor hood on and off. The rocker switch 15 serves the purpose of switching on and off as the main switch for the fan. The rocker switch 16 serves the purpose of stepping the speed of the fan motor up or down in two or more stages. A stage display 17 informs the user of the fan stage which is presently active.

FIG. 4B shows an extended version of the stepping switch having rocker buttons shown in FIG. 4A. In this variant, the fan stepping switch has four stages, which can be identified using the stage display 17. It is advantageous if the extended version has a memory function, such that the most recently used fan stage remains in the memory.

In a best embodiment, which is illustrated in FIG. 4C, the rocker stepping switch according to the invention has, in addition to the features of the variant illustrated in FIG. 4B, a run-on function. For this purpose, the rocker switch 15 is designed to have three switch positions. In the ZERO position, the rocker is not tipped, in the ON position of the fan, the rocker is tipped to the right, and in the ON position of the run-on function, the rocker is tipped to the left. Once the run-on time has expired, the rocker of the rocker switch 15 springs automatically from the position in which it is tipped to the left into the horizontal ZERO position.

The rocker stepping switch operates in a similar manner to the pushbutton stepping switch shown in FIGS. 2 and 3. In this case too, it is possible to choose between continuous operation and a temporally limited operating period (run-on). The activated run-on is identified using a luminous display. The operating period for the run-on can be factory-set, but in a further development may also be selected by the customer.

Both run-on operation and continuous operation can be interrupted by switching the rocker switch 15 to the ZERO position. The stepping switch 16 remains in the most recently used stage, providing a memory function.

The run-on function is not restricted to a specific stage. Rather, it can be initiated in any stage. Furthermore, the selected run-on stage may also be changed at any time during the run-on period. The fan then runs for the remaining time in the newly selected stage.

The run-on stage may also be interrupted by switching to continuous operation. In the case of this switching procedure from run-on to continuous operation, the fan continues to run in the most recently used run-on stage.

FIG. 5 shows a variant of the rocker stepping switch having an additional, temporally controlled intensive stage. This additional function can only be seen from the outside on the stage display 17 by means of a light-emitting diode which is especially assigned for the intensive stage.

As in the exemplary embodiments shown in FIGS. 4A to 4C, the stepping switch 16 likewise has a rocker whose rocking movement is converted into a rotary movement for the purpose of actuating a rotary switch. The individual fan stages, including the intensive stage, thus correspond to a rotary position of the rotary switch. The right-hand end position of the rotary switch has a spring-assisted stop. If it is desired to actuate the intensive stage, the spring force of the stop must be overcome by actuating the “(+)” button, and the knob of the rotary switch must be rotated further from the “stage 3” position. For this purpose, a further time-delay switching element, in addition to that for the run-on function, is inbuilt. The time-delay switching element can be used to hold the rotary switch magnetically in the “intensive stage” position.

Once the period of time for which the intensive stage is switched on has expired, the electromagnet triggers the intensive stage and the rotary switch is automatically pushed back to the “stage 3” position by the spring-assisted stop. The fan then continues to run in stage 3.

If it is desired to interrupt the intensive stage before the predetermined time has expired, the “−” button is actuated to switch back to stage 3. For this purpose, only the holding force of the magnet needs to be overcome. That is to say no electrical pulse for the electromagnet is required for interruption purposes.

One or more time-delay switching elements can be used for the switch block in FIG. 5. When using two time-delay switching elements, they may be programmed for different operating periods. It is thus possible, for example, for the intensive stage to be switched back after only five minutes to stage 3, and for the run-on function to be operated for 15 minutes. When using only one central time-delay switching element, it is used to drive two holding magnets. It is thus possible to further reduce the costs of the electronic components.

As already mentioned, the stepping switch having the pushbuttons shown in FIGS. 2 and 3 and the stepping switch having the rocker buttons shown in FIGS. 4A to 5 are preferably implemented by a flush-mounted rotary switch. It is therefore possible for the stepping switch also to have a rotary knob 18 as the control element as shown in FIGS. 6 and 7.

In the variant illustrated in FIG. 6, the light switch 19 is in the form of a conventional pushbutton switch, with the result that the light switch and the stepping switch are separate from one another. The stepping switch of the fan connects three basic stages of the speeds for the fan motor. As in the case of the above-described rocker stepping switch, the right-hand end position of the rotary switch has a spring-assisted stop for the time-delay switching element of the intensive stage. It thus functions as described above.

In the left-hand end position of the rotary switch, the switch reaches its ZERO position. This end position also has a spring-assisted stop. If the force of the stop is overcome, the run-on function is activated. The run-on function is controlled by a second time-delay switching element in an analogous way to the functioning of the intensive stage. Once the period of time for which the run-on function is switched on has expired, the magnet is released and the switching element is automatically pushed into the ZERO position by way of the spring-assisted stop. The device is thus switched off. The run-on function may also be switched off in this case in an analogous way to the intensive stage before the predetermined period of time has expired by the knob or the rotary knob 18 being actuated.

FIG. 7 shows a variant of a rotary knob in which the light switch is combined with the stepping switch. The fan stages are controlled in an analogous way to the previous version, i.e. a rotary movement of the knob is required for switching purposes. In contrast to this, the light switch is switched by actuating the knob in the axial direction. For this purpose, the knob is coupled to a microswitch. The knob can be stopped when the light is switched on by means of a hertz waveform having short displacement paths, or magnetically by means of a permanent magnet.

A further variant of the rotary stepping switch consists in the fan stages being controlled by rotary movement of the knob according to the embodiment in FIG. 6, the run-on stage likewise being activated by rotating the knob beyond the ZERO position and by the intensive stage being connected in an analogous manner to the embodiment shown in FIG. 7 by pressing the knob. In this case, the initially active stage is switched off and the intensive stage is activated. The knob is held magnetically in the “intensive stage ON” position. Once the time for the intensive stage has expired, the magnet is released and the switching element switches to the originally used stage, i.e. to any desired stage which has previously been used.

The intensive stage can be interrupted at any time by pulling the knob. The switching element then switches automatically back to the originally used stage.

In the case of the embodiment with the rotary switch, too, versions having one or two time-delay switching elements, as have already been described above, are conceivable. It is likewise also possible to use the concept of the modular system here. This would make switches having an intensive stage and run-on, switches having only an intensive stage, switches having only run-on and simple stepping switches without any extras possible.

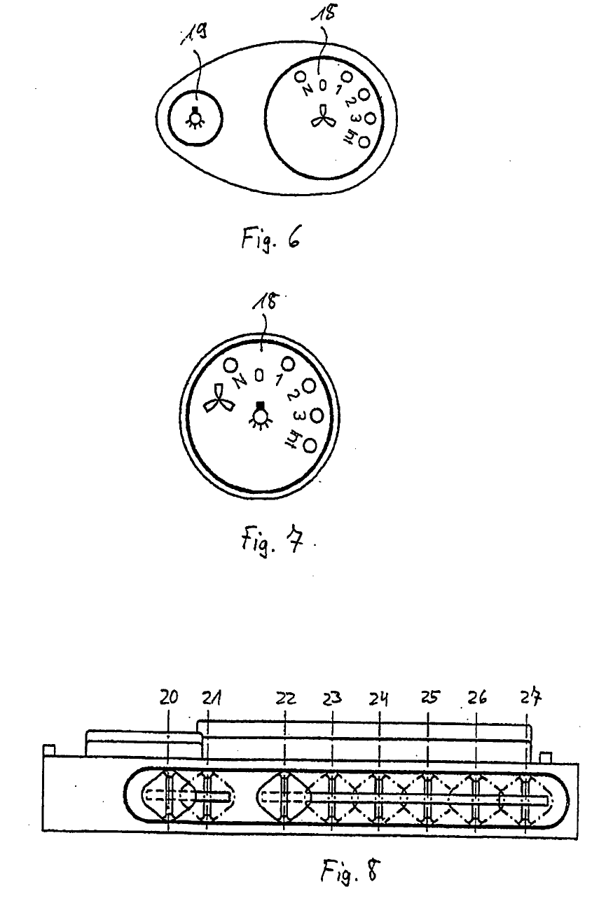

FIG. 8 shows the implementation of the stepping switch in the form of a sliding switch. The light switch has the switch positions “ON” 20 and “OFF” 21. The fan stepping switch has the switching stages “run-on” 22, “off” 23, “stage 1” 24, “stage 2” 25, “stage 3” 26 and “intensive” 27. The right-hand end position of the sliding switch in turn has a spring-assisted stop of a time-delay switching element which has already been described above. If it is desired to interrupt the intensive stage before the predetermined time has expired, the slide is pushed back to the “stage 3” position. For this purpose, only the holding force of the magnet needs to be overcome.

In the left-hand end position of the sliding switch, the switch reaches its ZERO position. For the purpose of activating a run-on function, this ZERO position may be overcome counter to the spring force of a second time-delay switching element. Here too, in principle the same variants of the stepping switch are conceivable as in the case of the pushbutton, rocker or rotary knob stepping switch.

In summary, it can be established that an electromechanical switch which is based in terms of its operating characteristics on the electronic control systems already used is implemented using the above concept, but is considerably more favorable in terms of price. This is possible owing to robust, mass-produced parts being combined with modified and newly developed components to form a switch having a time-delay function. This new switch makes it possible, in addition, to implement new device block switches having two or more switches usually also of reduced physical size. The field of application for the switch or block switch is not limited to the field of extractor hoods but may also extend to any household appliances, air-conditioning or ventilation devices, miniature devices etc.

1. A switching apparatus for controlling a device, comprising:
a mechanical stepping switching element connected to control the device and configured to assume a plurality of switching positions;
said switching element being configured to assume at least one first switching position by manual actuation; and
electrical means disposed to inject an electrical pulse to reset said switching element from said first switching position to a second switching position.

2. The switching apparatus according to claim 1, which comprises a device for holding said stepping switching element in said first position by magnetic force.

3. The switching apparatus according to claim 2, which comprises a permanent magnet for holding said switching element in said first switching position by magnetic force, and an electromagnet for generating a magnetic field to be superimposed on the magnetic field of said permanent magnet.

4. The switching apparatus according to claim 1, which comprises a spring element disposed for assisting a reset movement of said switching element from said first switching position to said second switching position.

5. The switching apparatus according to claim 4, which comprises a spring element disposed to bias said switching element with a spring force directed towards said second switching position, and wherein said electromagnet is configured to temporarily reduce the magnetic field of said permanent magnet by the electrical pulse, such that said switching element is reset by the spring force of said spring to said second switching position.

6. The switching apparatus according to claim 1, which comprises a time-delay switching element configured for emitting the electrical pulse for resetting said switching element after a selectable time period.

7. The switching apparatus according to claim 1, wherein said stepping switching element includes a rotary switch.

8. The switching apparatus according to claim 7, wherein said rotary switch is actuated by way of at least two pushbuttons or a rocker button.

9. The switching apparatus according to claim 8, which further comprises a stage display indicating a selected operational stage of the device.

10. The switching apparatus according to claim 9, wherein said stage display has a plurality of light-emitting diodes disposed between said pushbuttons.

11. The switching apparatus according to claim 1, wherein said stepping switching element includes a sliding switch.

12. In combination with a household appliance, the switching apparatus according to claim 1 configured to control the household appliance.

13. The combination according to claim 12, wherein the apparatus is configured for selection of a plurality of intensity stages of the household appliance, including an intensive stage and/or run-on stage, to be connected by said stepping switching element.

14. The combination according to claim 13, wherein, during operation in the run-on stage, other functionalities of the household appliance remain freely selectable.

15. The combination according to claim 14, wherein, during operation in the run-on stage, all other intensity stages of the household appliance remain freely selectable.

16. In combination with a ventilation device, the switching apparatus according to claim 1 configured to control the ventilation device.

17. The combination according to claim 16, wherein the switching apparatus is configured for selection of a plurality of intensity stages of the ventilation device, including an intensive stage and/or run-on stage, to be connected by said stepping switching element.

18. In combination with an air conditioning assembly, the switching apparatus according to claim 1 configured to control the air conditioning assembly.

19. The combination according to claim 18, wherein the switching apparatus is configured for selection of a plurality of intensity stages of the air conditioning assembly, including an intensive stage and/or run-on stage, to be connected by said stepping switching element.
